(19) United States
(12) Patent Application Publication
(10) Pub. No.: US 2009/0174786 A1
(43) Pub. Date: Jul. 9, 2009

(54) METHOD AND APPARATUS FOR MANAGING CAMERA SETTINGS

(75) Inventor: Vinod Cherian JOSEPH, Byrasandra (IN)

Correspondence Address: THE FARRELL LAW FIRM, LLP, 290 Broadhollow Road, Suite 210E, Melville, NY, 11747, US

(73) Assignee: SAMSUNG ELECTRONICS CO., LTD., Suwon-si (KR)

(21) Appl. No.: 12/345,046

(22) Filed: Dec. 29, 2008

(30) Foreign Application Priority Data
Dec. 28, 2007 (IN) 3147/CHE/2007

(51) Int. Cl. H04N 5/228; G06K 9/40

(52) U.S. Cl. 348/222.1; 382/254

(57) ABSTRACT

A method for managing camera settings in an electronic device is provided. One or more parameters associated with an electronic device are determined. A camera of the electronic device is configured, based on the one or more parameters. An image based on the profile is captured. Quality of the image is checked against a predefined threshold. The image is then processed in accordance with the configuration and a result of the quality check.

### PRIORITY

This application claims priority under 35 U.S.C. §119(a) to an application entitled “Method and Apparatus for Managing Camera Settings” filed in the Indian Patent Office on Dec. 28, 2007, and assigned Serial No. 3147/CHE/2007, the contents of which are incorporated herein by reference.

### FIELD OF THE INVENTION

The present invention relates generally to a camera of an electronic device, and more particularly, to a method and apparatus for managing camera settings of the electronic device.

### BACKGROUND OF THE INVENTION

In order to capture an image having a desired quality with a camera, camera settings of an electronic device need to be properly adjusted. Further, it is also desirable for the camera settings to be adjusted quickly so that an instance at which a user desires to take the image is not lost.

One existing technique of adjusting camera settings provides the user with predefined modes for camera settings. However, manual intervention is required to activate such modes. When further processing of an image is desired in order to obtain a desired output from the image, additional applications are required for the processing. For example, in order to obtain details from a business card, an image of the business card is first taken. The image of the business card is then stored and processed using various applications. For example, an Optical Character Recognition (OCR) application may be used to generate the business card details. The business card details are then stored by the user. The entire process is time consuming and requires human intervention.

Thus, there is a need for an efficient technique for managing camera settings.

### SUMMARY OF THE INVENTION

The present invention has been made to address at least the above problems and/or disadvantages and to provide at least the advantages described below. Accordingly, an aspect of the present invention provides a method and apparatus for managing camera settings in an electronic device.

According to one aspect of the present invention, a method for managing camera settings in an electronic device is provided. One or more parameters associated with an electronic device are determined. A camera of the electronic device is configured based on the one or more parameters. An image is captured in accordance with the configuration. A quality of the image is checked against a predefined threshold. The image is processed in accordance with the configuration and a result of the quality check.

The one or more parameters may include at least one of: a location of the electronic device; a time at the location of the electronic device; a date at the location of the electronic device; a usage history of the camera of the electronic device; an environment in which the electronic device is located; and an input from a user of the electronic device.

Configuring the camera may include activating a profile, wherein the profile is stored in the electronic device and comprises image capture settings, image processing settings and desired output settings.

Configuring the camera may further include receiving inputs corresponding to one or more settings in the profile, and updating the profile based on the inputs.

Processing the image may comprise displaying the image if the predefined threshold is met, and saving the image.

Processing the image may comprise auto-correcting the image if the quality is less than the predefined threshold, displaying the image, and saving the image.

Processing the image may further comprise storing a history based on the auto-correcting for subsequent use.

Processing the image may comprise generating desired output from the image.

According to another aspect of the present invention, a method for managing camera settings in an electronic device is provided. One or more profiles for a camera of the electronic device are created. One of the one or more profiles is activated based on one or more parameters associated with the electronic device. An image is captured in accordance with the profile. A quality of the image is checked against a predefined threshold. The image is processed in accordance with the profile and a result of the quality check.

According to a further aspect of the present invention, an electronic device is provided. The electronic device includes a camera for capturing an image. The electronic device also includes a memory for storing one or more profiles associated with the camera. The electronic device further includes a processor for managing settings of the camera using the one or more profiles and a display for displaying the image.

The processing module may comprise an auto-correcting module for auto-correcting the image if a quality of the image is less than a predefined threshold.

### BRIEF DESCRIPTION OF THE DRAWINGS

The above and other aspects, features and advantages of the present invention will be more apparent from the flowing detailed description when taken in conjunction with the accompanying drawings, in which:

FIG. 1 is a block diagram of an electronic device, in accordance with an embodiment of the present invention;

FIG. 2a and FIG. 2b is a flowchart illustrating a method for managing camera settings in accordance with an embodiment of the present invention; and

FIG. 3 is a flow chart illustrating a method for managing camera settings in accordance with another embodiment of the present invention.

### DETAILED DESCRIPTION OF THE PREFERRED EMBODIMENTS

Preferred embodiments of the present invention are described in detail with reference to the accompanying drawings. The same or similar components are designated by the same or similar reference numerals although they may be illustrated in different drawings. Detailed descriptions of constructions of processes known in the art may be omitted to avoid obscuring the subject matter of the present invention.

Embodiments of the present invention provide a method and system for managing camera settings.

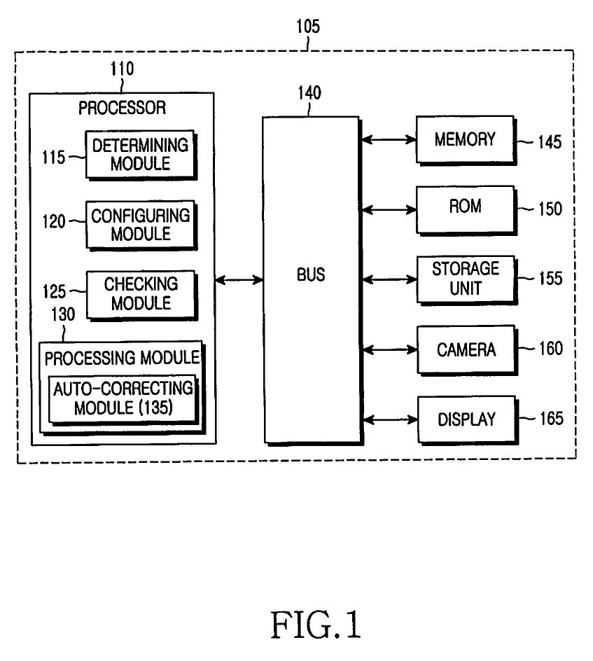

FIG. 1 is a block diagram illustrating an electronic device 105, according to an embodiment of the present invention. The electronic device 105 includes a processor 110, a memory 145, a Read Only Memory (ROM) 150, a storage unit 155, a camera 160 and a display 165 which are coupled to a bus 140.

Examples of the electronic device 105 include, but are not limited to, computers, laptops, mobile devices, computing devices, hand held devices, and Personal Digital Assistants (PDAs).

The bus 140, or another communication mechanism for communicating information, is coupled with the processor 110 for processing information. The electronic device 105 also includes the memory 145, such as a Random Access Memory (RAM) or other dynamic storage device, coupled to the bus 140 for storing information that can be used by the processor 110. The memory 145 can be used for storing temporary variables or other intermediate information. The electronic device 105 further includes the ROM 150, or other static storage device, coupled to the bus 140 for storing static information for the processor 110. The storage unit 155, such as a magnetic disk or optical disk, is provided and coupled to the bus 140 for storing information.

The processor 110 can be coupled via the bus 140 to the display 165, for example a Cathode Ray Tube (CRT) display, a Liquid Crystal Display (LCD), or a Light Emitting Diode (LED) display, for displaying information to a user.

The electronic device 105 can further include an input device. The input device, including alphanumeric and other keys, can also be coupled to the bus 140 for communicating information and command selections to the processor 110. The input device can be included in the display 165, for example, when the display 165 is a touch screen.

Various embodiments of the present invention use the electronic device 105 in implementing the techniques described herein. In one embodiment of the present invention, the techniques are performed by the processor 110 using information included in the memory 145. The information can be read into the memory 145 from another machine-readable medium, such as the storage unit 155.

The term “machine-readable medium,” as used herein, refers to any medium that participates in providing data that causes a machine to operate in a specific fashion. In an embodiment of the present invention implemented using the electronic device 105, various machine-readable mediums are involved, for example, in providing information to the processor 110. The machine-readable medium can be a storage media. Storage media includes both non-volatile media and volatile media. Non-volatile media includes, for example, optical or magnetic disks, such as the storage unit 155. Volatile media includes dynamic memory, such as the memory 145. All such media must be tangible to enable the information carried by the media to be detected by a physical mechanism that reads the information into a machine.

Common forms of machine-readable medium include, for example, a floppy disk, a flexible disk, hard disk, magnetic tape, any other magnetic medium, a CD-ROM, any other optical medium, punchcards, papertape, any other physical medium with patterns of holes, a RAM, a Programmable ROM (PROM), an Erasable PROM (EPROM), a FLASH-EPROM, and any other memory chip or cartridge.

In another embodiment of the present invention, the machine-readable medium can be a transmission media including coaxial cables, copper wire and fiber optics, including the wires of the bus 140. Transmission media can also take the form of acoustic or light waves, such as those generated during radio-wave and infra-red data communications.

The processor 110 includes a determining module 115, a configuring module 120, a checking module 125 and a processing module 130. The processing module 130 includes an auto-correcting module 135.

The camera 110 can be activated by the processor 110 to capture an image. In one embodiment of the present invention, upon activation of the camera 110, the display 165 can provide a list of profiles for a user to select. Examples of the profile include, but are not limited to, Business Card Profile, Painting Profile, Book Profile, Notes Profile, Text Profile, Photo Profile, Sporty Profile, Webcam Profile and Print Profile. Each profile includes specific settings that enable the images to be captured and processed as per user requirements. In some embodiments, the profile can include sub profiles and further levels of sub-profiles. For example, Photo Profile can include sub profiles of Scenic, Portrait, Night and Sports.

In another embodiment of the present invention, a profile can be activated automatically. One or more parameters can be determined automatically by the determining module 120. The one or more parameters include, but are not limited to, location of the electronic device, time at the location of the electronic device, date at the location of the electronic device, usage history of the camera of the electronic device, environment in which the electronic device is located, and an input from a user of the electronic device. Using the one or more parameters, the profile is automatically selected and the camera is configured according to the profile by the configuring module 120. For example, when a user enters an art-museum with a Global Positioning System (GPS) enabled mobile device, the location of the mobile device and the environment of the locality is determined and the profile is automatically set to Painting Profile. This allows the user to capture all photos as paintings.

The profiles can be stored in hard disk drive, for example the storage unit 155 of the electronic device 105.

The image is captured based on the configuration and is sent to a checking module 125. The checking module 125 checks the quality of the image against a predefined threshold.

The checked image is sent to the processing module 130. The processing module 130 further processes the image to provide the desired output to the user. The auto-correcting module 135 performs auto-correction of the image. The auto-correcting module 135 automatically reconfigures the camera 110 based on previous learning and the parameters, and the image is retaken. The retaken image is merged with the image and the predefined threshold is checked. Several shots can be taken until the predefined threshold is met. The image is then saved in the storage unit 155.

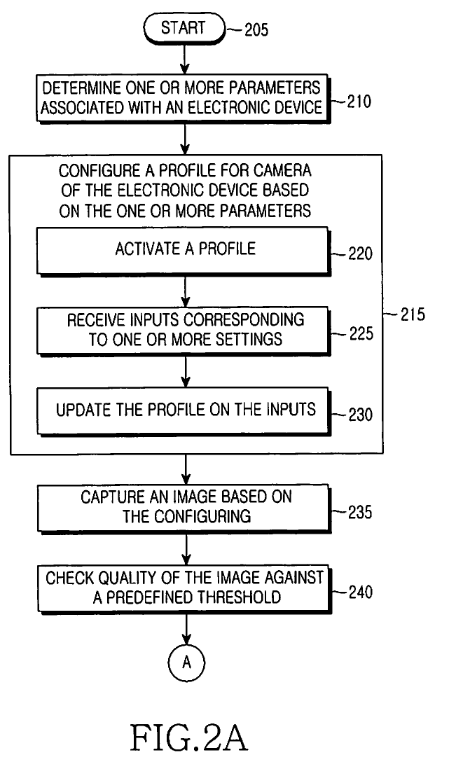

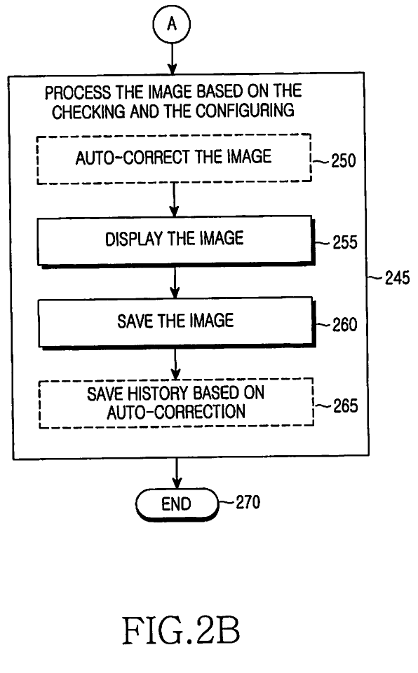

FIG. 2a and FIG. 2b are a flow chart illustrating a method for managing camera settings in accordance with an embodiment of the present invention.

A camera is included in an electronic device of a user.

The method begins at step 205.

At step 210, one or more parameters associated with the electronic device are determined. The one or more parameters include location of the electronic device, time at the location of the electronic device, date at the location of the electronic device, environment in which the camera is located, and an input from the user of the electronic device. The parameters can be determined by fetching data from various servers. For example, time and date information can be fetched from time server. The parameters can also be input by the user. The parameters can also be determined using one or more sensors connected to or present in the electronic device.

At step 215, a profile for the camera of the electronic device is configured based on the one or more parameters. Step 215 includes step 220, step 225 and step 230.

At step 220, a profile is activated. The profile can be activated automatically based on the parameters. For example, when a user enters an art-museum with a Global Positioning System (GPS) enabled mobile device, the location of the mobile device and the environment of the locality is determined and the profile is automatically set to Painting Profile.

In one embodiment of the present invention, the profile can be activated manually. A list of profiles can be displayed to the user based on the parameters. Examples of the profile include but are not limited to Business Card Profile, Painting Profile, Book Profile, Notes Profile, Text Profile, Photo Profile, Sporty Profile, Webcam Profile and Print Profile. Each profile includes specific settings that enable the images to be captured and processed as per user requirements. Examples of the settings can include image capture settings, image processing settings, and desired output. Examples of image capture settings include but are not limited to red eye, resolution, flash, pixel, zoom and other picture configurations for the image. Examples of image processing settings include, but are not limited to, converting image into text, extracting details from the image, validating the details, and emailing the details. Examples of desired output include, but are not limited to, a format for saving the output and a format for saving the image, for example, saving the business card details in a vCard.

In some embodiments of the present invention, the profile can include sub profiles and further levels of sub-profiles. For example, Photo Profile can include sub profiles of Scenic, Portrait, Night and Sports.

At step 225, inputs are received corresponding to the settings. The user may modify the image capture settings corresponding to the profile to ensure quality while capturing images.

At step 230, the profile is updated based on the inputs. For example, the user may modify the setting of zoom from 9× to 6×. 6× can then be set as the default in the profile.

At step 235, an image is captured by the camera based on the configuring.

At step 240, the quality of the image is checked against a predefined threshold. The predefined threshold can be based on the settings in the profile.

At step 245, the image is processed based on the checking and the configuring. Step 245 includes step 250, step 255, step 260, and step 265.

At step 250, the image is auto-corrected if the quality of image is less than the predefined threshold. The auto-correction is performed by retaking the image. The image is retaken based on previous learning of the camera, if available, and the parameters. The retaken image is merged with the image to obtain a combined image. The merging can be performed using various techniques, for example pixel collaboration technique. If the combined image quality is greater than an expected minimum target then step 255 is performed, else several shots are retaken until the predefined threshold is met.

At step 255, the combined image is displayed to the user.

In one embodiment of the present invention, the user is given a choice for storing the original image or the combined image.

In some embodiments of the present invention, the image is processed based on the image processing settings in the profile. For example, if the profile is Text Profile then the image can be processed to generate notes.

At step 260, the image is saved.

In some embodiments of the present invention, desired output is also saved along with the image. For example, if the profile is Text Profile then the image can be processed to generate notes. The notes can then be saved and presented to the user.

At step 265, a history based on the auto-correcting is stored for subsequent use. This enables better camera results of images for future tasks.

The method ends at step 270.

The profile can be updated dynamically at any step based on various factors, for example usage history, changing parameters and user inputs.

When a user receives a business card during a meeting at an office. The location of the meeting is determined using GPS and the Business Card Profile is automatically set. Any image captured is identified as a business card. The business card is converted and stored in a Virtual Card and in Contacts list. The text identified is stored in relevant fields such as name, company, phone, fax and email. The user is informed of the vCard conversion. The image can then be deleted based on memory space.

The auto-learning feature can be enabled in the electronic device. The electronic device learns that the user is capturing business card image based on the parameters detected and activate a profile. The image of the business card is then captured. The profile can be updated by comparing the image with sample template configurations stored in the phone, and adding features like converting the image into vCard format and storing information in vCard to the profile if the profile is not already configured to perform the converting and storing steps.

If the user is taking notes using the electronic device during a meeting then the notes can be considered as inputs from the user and a text profile can be activated. The images captured are converted into text automatically and saved.

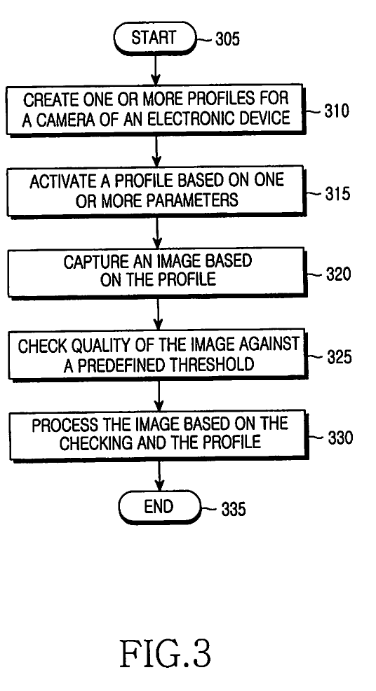

FIG. 3 is a flow chart illustrating a method for managing camera settings in accordance with another embodiment of the present invention.

A camera is included in an electronic device of a user.

The method starts at step 305.

At step 310, one or more profiles for a camera of an electronic device are created.

The user may define a group of settings for a profile. The profile is assigned a name and is stored in the camera. Examples of the settings can include image capture settings, image processing settings, and desired output.

At step 315, a profile based on one or more parameters is activated. The one or more parameters are associated with the electronic device.

The one or more parameters include location of the electronic device, time at the location of the electronic device, date at the location of the electronic device, environment in which the user's camera is located and an input from a user of the electronic device.

At step 320, an image based on the profile is captured by the camera.

At step 325, quality of the image is checked against a predefined threshold.

At step 330, the image is processed based on the checking and the profile. If the quality of image is less than the predefined threshold, the image can be retaken. Several shots can be retaken until the predefined threshold is met.

If the quality of image is greater than the predefined threshold, then the image is displayed and processed based on the settings.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for managing camera settings in an electronic device, the method comprising the steps of:
determining one or more parameters associated with the electronic device;
configuring a camera of the electronic device based on the one or more parameters;
capturing an image in accordance with the configuration of the camera;
checking a quality of the image against a predefined threshold; and
processing the image in accordance with the configuration of the camera and a result of the quality check.

2. The method of claim 1, wherein the one or more parameters comprise at least one of:
a location of the electronic device;
a time at the location of the electronic device;
a date at the location of the electronic device;
a usage history of the camera of the electronic device;
an environment in which the electronic device is located; and
an input from a user of the electronic device.

3. The method of claim 1, wherein configuring the camera comprises:
activating a profile, wherein the profile is stored in the electronic device and comprises image capture settings, image processing settings and desired output settings.

4. The method of claim 3, wherein configuring the camera further comprises:
receiving inputs corresponding to one or more settings in the profile; and
updating the profile based on the inputs.

5. The method of claim 1, wherein processing the image comprises:
displaying the image if the predefined threshold is met; and
saving the image.

6. The method of claim 1, wherein processing the image comprises:
auto-correcting the image if the quality is less than the predefined threshold;
displaying the image; and
saving the image.

7. The method of claim 6, wherein processing the image further comprises:
storing a history based on the auto-correcting for subsequent use.

8. The method of claim 1, wherein processing the image comprises:
generating desired output from the image.

9. A method for managing camera settings in an electronic device, the method comprising the steps of:
creating one or more profiles for a camera of the electronic device;
activating one of the one or more profiles based on one or more parameters associated with the electronic device;
capturing an image in accordance with the profile;
checking a quality of the image against a predefined threshold; and
processing the image in accordance with the profile and a result of the quality check.

10. An electronic device comprising:
a camera for capturing an image;
a memory for storing one or more profiles associated with the camera;
a processor for automatically managing settings of the camera using the one or more profiles; and
a display for displaying the image.

11. The electronic device of claim 10, wherein the one or more parameters comprise at least one of:
a location of the electronic device;
a time at the location of the electronic device;
a date at the location of the electronic device;
a usage history of the camera of the electronic device;
an environment in which the electronic device is located; and
an input from a user of the electronic device.

12. The electronic device of claim 10, wherein the processing module comprises:
an auto-correcting module for auto-correcting the image if a quality of the image is less than a predefined threshold.
